(19) United States
(12) Patent Application Publication
(10) Pub. No.: US 2022/0391507 A1
(43) Pub. Date: Dec. 8, 2022

(54) MALWARE IDENTIFICATION

(71) Applicant: Hewlett-Packard Development Company, L.P., Spring, TX (US)

(72) Inventors: Christopher Ian Dalton, Bristol (GB); David Plaquin, Bristol (GB); Pierre Belgarric, Bristol (GB); Titouan Lazard, Bristol (GB)

(73) Assignee: Hewlett-Packard Development Company, L.P., Spring, TX (US)

(21) Appl. No.: 17/761,646

(22) PCT Filed: Oct. 25, 2019
(86) PCT No.: PCT/US2019/058075

§ 371 Date: Mar. 18, 2022

(51) Int. Cl. G06F 21/56; G06F 21/85

(52) U.S. Cl. CPC G06F 21/566; G06F 21/85

(57) ABSTRACT

In an example there is provided an apparatus for a computing system. The apparatus comprises a central processing unit (CPU) and at least one further hardware component. The apparatus comprises a probe communicatively coupled with the hardware component and the CPU, to intercept communication between the hardware component and CPU and an inspection module communicatively coupled to the probe, to access communication data intercepted at the probe relating to communication between the hardware component and CPU determine a state of a process executing on the CPU, on the basis of the communication data and apply a model to the state to infer malicious activity on the CPU.

### BACKGROUND

Malicious software, also known as malware, can have a devastating impact on businesses and individuals. Sophisticated malware attacks can result in large scale data breaches. Data breaches can leave millions of users exposed to attackers. This can be highly damaging to a business's reputation. Unfortunately, a malware attack can be challenging to identify. Malware may be well hidden and it can be difficult to take appropriate remediation action to remove the malware once it has been identified. In some cases, malware operates at a low level of the computing system architecture. In these cases, the malware is able to evade detection with simple methods.

### BRIEF DESCRIPTION OF THE DRAWINGS

FIG. 1 is a schematic diagram showing a computing system according to examples.

FIG. 2 is a block diagram showing a method of identifying malicious activity on a computing system.

FIG. 3 shows a processor associated with a memory comprising instructions for identifying malicious activity on a computing system.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

Modern computing systems are under constant threat from attacks by malicious software, also known as malware. Malware comes in many different forms. Some malware targets specific operations in a computing system, with a goal of obtaining particular kinds of data from users. Other malware causes the system to connect to a remote server under the control of attackers. Some types of malware such as ransomware may perform undesirable operations on the computing system such as encrypting the disk to deny access to a user, or swamping the memory with read/write operations to render the computing system unusable.

Computing systems may run antivirus software in the operating system (OS). Some antivirus software programs are arranged to monitor the system and safeguard the system against malicious activity. In response to a positive detection of malware, antivirus software may take remedial action to remove the malware and restore the system to a safe operating state. Certain antivirus software programs use triggers to identify malicious activity. These programs use agents that run in the OS to monitor calls to memory and read/write operations to disk. A trigger may be set off in the software when unusual activity is occurring on the computing system.

Sophisticated malware can circumvent antivirus software by targeting privileged components in the OS such as the kernel. For example, a rootkit may attack code, such as the boot loader, which is executed by the computing system when the system is first booted up. In this case, the rootkit can seize control of the system before any antivirus software has been activated on the system. Rootkits may also employ cloaking techniques to subvert detection.

It becomes difficult for software executing in the OS to reliably detect malware in a deeply compromised system. In particular, antivirus software which operates at the same or a lower level of privilege as the OS may have inherent limitations to detect malware, such as a rootkit, that attacks components that operate at a higher privilege level. Moreover, a system which is compromised at the kernel level may be incapable of taking remediation action if the control mechanisms that enable the action to be taken are also under the control of the attacker.

Networked computing systems may also implement Intrusion Detection Systems (IDS). IDSs may run completely outside of the computing platforms which they protect. IDSs monitor the network traffic coming in and out of the platform and detect malicious activity on the basis of the data packets that are being sent over the network. IDSs may be limited with respect to the operations which are monitored in the computing system. In particular, IDSs are in general, not designed to observe certain input/output operations occurring within the platform. IDS are not well suited for detection of malware in deeply compromised systems.

The methods and systems described herein address detection issues that arise where sophisticated malware attacks target privileged components in a computing system. Examples described herein are used to identify and infer malicious activity on a computing system, based on data that is communicated between the central processing unit (CPU) of the computing system and hardware components outside of the CPU.

In some modern computing architectures, hardware components are interconnected via a network of serial connections that is controlled by a central hub on the motherboard.

Data is communicated between components and the CPU in a manner analogous to how data is communicated in a packet-based computing network. Data is communicated from a component to a bridge where it is packetized into a data packet. The data packet contains a header portion which comprises an address of a target hardware component and a body portion which comprises data to be communicated to the targeted component. When the data packet reaches the component, it is depacketized so that the body portion can be read from the packet by the target device.

In examples of the methods and systems described herein, probes are inserted on to the motherboard of the computing system. The probes are arranged to monitor data packets that are communicated between the CPU and components outside of the CPU. Data packets are intercepted at the probes and are forwarded to an inspection module. The probes may be configured to filter the communication data and forward packets to the inspection module based on the type, source or destination of the data.

In examples described herein, when the inspection module receives communication data from the probes, a hypothetical state of a process running on the CPU is reconstructed from the data.

The inspection module is arranged to apply a model to the state to infer behaviour of the CPU. According to examples the model may describe a set of rules for state transition of a finite state machine, where the states correspond to the expected states of the process. The model is used to infer whether malicious activity is occurring on the CPU. The inspection module can take remediation action if malicious activity is detected on the CPU. Examples of remediation actions include restoring the computing system to a known safe state, or performing filtering and modification of packets using the probes.

The methods and systems described herein are implemented at the hardware level and are local to the platform. The inspection module is isolated from the CPU using hardware separation. In some cases, the inspection module is implemented using a Field Programmable Gate Array (FPGA), micro-controller, or a dedicated Application-Specific Integrated Circuit (ASIC). The inspection module may be implemented in a secure module which is inaccessible to the rest of the platform.

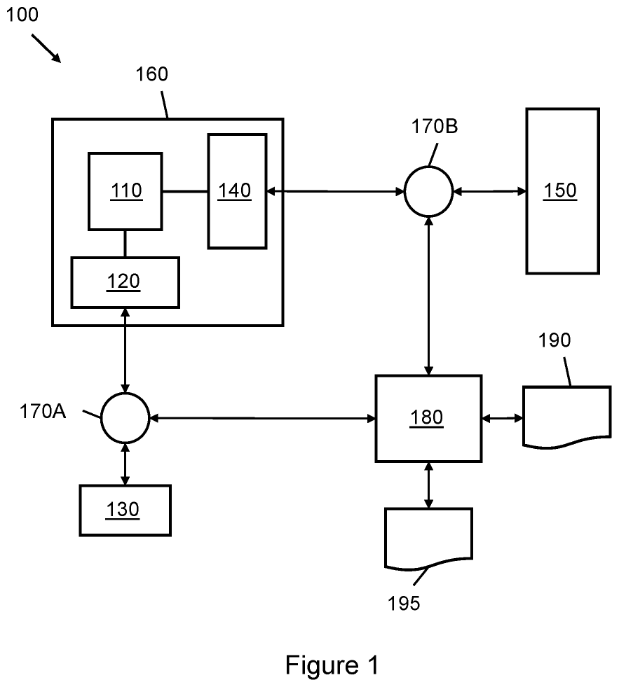

FIG. 1 is schematic diagram showing a computing system 100 according to an example. The system 100, shown in FIG. 1, may be used in conjunction with the other methods and systems described herein.

The computing system 100 comprises a central processing unit (CPU) 110 that is responsible for executing programs on the computing system 100. In examples described herein, a process that is executed on the CPU 110 may be described in terms of its states. A state of a process refers to the data which is temporarily stored in memory during the execution of the process on the CPU 110. This includes data which is stored in memory by the program code as variables and constants. The state of the CPU 110, comprises the complete state of the processes running on the CPU 110 and memory at any given point in time.

The CPU 110 is communicatively coupled to a bus interface 120. The bus interface 120 is a data interface that provides logic to allow hardware components to communicate with the CPU 110. The bus interface 120 is in communication with a device 130. In FIG. 1, the term “device” in relation to device 130 is used loosely—the bus interface 120 may be an internal bus for connecting internal components of the computing system 100 to the motherboard. In another example, the bus interface 120 connects external peripheral input/output devices such as a mouse, screen or keyboard to the computing system 100.

The computing system 100 comprises a memory controller 140. The memory controller 140 is communicatively coupled to a main memory 150. The memory controller 140 comprises logic to manage the flow of data between the CPU 110 and the main memory 150. This includes logic to perform read and write operations to the main memory 150 on instruction from the CPU 110. In some examples of the computing system 110, the memory controller 140 may comprise logic to perform packetization and depacketization of data.

In the example shown in FIG. 1, the CPU, bus interface 120, and memory controller 140 are integrated in a system-on-chip 160 design. In other examples, the bus interface 120 and memory controller 140 may be physically separate chips from the CPU 110.

The computing system 100 shown in FIG. 1 further comprises two probes 170A and 170B. The probe 170A is inserted on the motherboard of the computing system 100 between the bus interface 120 and device 130. The probe 170B is inserted between the memory controller 140 and main memory 150. The probes 170 are arranged to intercept communication data that is communicated between the CPU 110, device 130 and main memory 150.

The computing system 100 comprises an inspection module 180. The inspection module 180 may be a standalone chip on the motherboard, which is physically separate from the CPU 110. In another example, the inspection module 180 is implemented in logic in a hardware device such as a dedicated secure hardware module which is physically separate from the CPU 110.

The inspection module 180 is communicatively coupled to the probes 170. The inspection module 180 is arranged to access communication data that is intercepted at the probes 170 that relates to communication between the hardware components—either the device 130 or memory 150, and the CPU 110. According to examples, the probes 170 are arranged to forward intercepted communication data to the inspection module 180 such that the inspection module 180 is able to access the communication data.

The inspection module 180 is arranged to determine a state of a process executing on the CPU 110, on the basis of the communication data that is received at the probes 170. The state that is determined by the inspection module 180 is constructed on the basis of an aggregation of the communication data.

The inspection module 180 is arranged to apply a model 190 to infer whether malicious activity is occurring on the CPU, on the basis of the state. According to examples the model 190 comprises a set of state transition rules for a finite state machine that models the process. The inspection module uses the model 190 to determine the next state on the basis of the input state from the communication data, as determined by the state transition rules. The next state may be compared against an expected state to infer if malicious activity may be occurring on the CPU 110.

In a second example, a probabilistic or heuristic state model of the computing system 110 is used to determine a subsequent state based on the state determined from the intercepted communication data.

In a further example, a neural network or other learning-based algorithm may be implemented by the inspection module 180, to infer information about the process execution on the CPU 110. In particular, the inspection module 180 may be trained on a set of training data to construct a classifier. The classifier may be applied to a new state which is determined from the communication data, to infer if the process is a malicious process.

According to examples described herein, the inspection module 180 is arranged to apply a remediation action to the computing system on the basis of an output of the model 190. In one case, the remediation action may comprise logging the output of the model 190. In other examples, the remediation action comprises restoring the process or computing system 100 to a previous safe state or rebooting the computing system 100.

In further examples, the inspection module 180 is arranged to modify the operation of the computing system 100. In an example the inspection module 180 may apply a remediation action via the probes 170. In particular, the inspection module 180 may be arranged to control the probes 170 to block, modify, rewrite and/or reroute communication data between the memory 150 or device 130 and the CPU 110.

In some examples, the inspection module 180 is arranged to configure the probes 170 to forward communication data to the inspection module 180 on the basis of a policy 195. The policy 195 is implemented as a set of filtering rules that, when implemented at the probes 170, cause the probes 170 to filter communication data for forwarding to the inspection module 180.

In some cases, communication data is filtered on the basis of the source or destination of the data packets. In other cases, communication data may be filtered based on the direction or type of communication data intercepted which is intercepted at the probe 170.

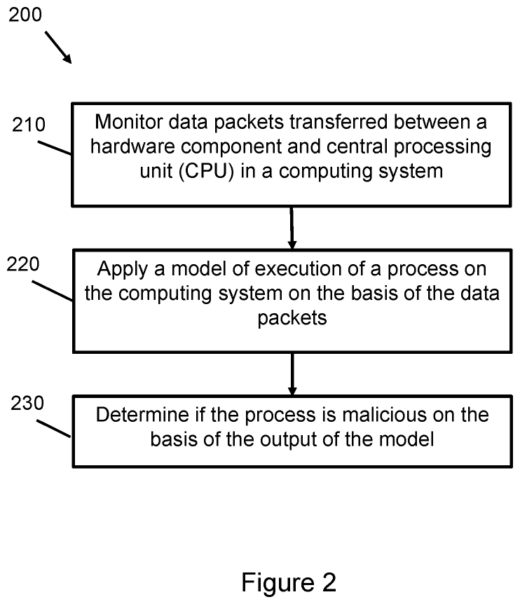

FIG. 2 is a block diagram showing a method 200 of identifying malicious activity on a computing system. The method 200 shown in FIG. 2 may be implemented on the computing system 100 shown in FIG. 1. In particular, the method 200 may be implemented by the inspection module 180 in conjunction with the probes 170.

At block 210 the method 200 comprises monitoring data packets transferred between a hardware component and central processing unit (CPU) in a computing system. According to examples, the monitoring may be performed at the probes 170. The data packets may comprise a header a body portion. The body portion corresponds to data that is transferred between, for example, the device 130 and bus interface 120 and/or the main memory 150 and memory controller 140.

At block 220, the method 200 comprises applying a model of execution of a process on the computing system on the basis of the data packets. As described in conjunction with the computing system 100, the inspection module 180 applies the model 190.

The model may be a state model comprising a set of state transition rules for a monitored process. According to examples, applying the model on the basis of the data packets may comprise constructing a hypothetical or aggregated state of a process on the computing system, from the received data packets, and applying the model to the aggregated state.

At block 230, the method 200 comprises determining if the process is malicious on the basis of the output of the model. According to examples described herein, determining if the process is a malicious process comprises determining, based on the current state of the process, that the subsequent states are not following an expected execution pattern for the process. This may be indicative of the fact that the process is a malicious process or that the process has been corrupted.

According to examples, the method 200 may further comprise applying a remediation action on the basis of the determination. When the method 200 is executed by computing system 100 shown in FIG. 1, the inspection module 180 may be arranged to apply a remediation action when a process is identified as a malicious process. In other examples, a separate logical entity may perform the remediation action. For example, the remediation action may be taken by a dedicated hardware component coupled to the CPU 110.

In some cases, applying a remediation comprises issuing a command to the CPU and executing a remediation action at the CPU on the basis of the command. This may be performed by the inspection module 180 shown in FIG. 1. The command is, according to certain examples, a command to restore the computing to a prior state, reboot the computing system or shutdown the computing system.

In further examples, the method 200 comprises modifying the communication of data packets between the hardware component and the CPU. In examples described herein, modifying the communication of data packets between the hardware component and the CPU comprises accessing a policy specifying configuration rules for the communication of data packets between the hardware component and CPU and reconfiguring communication of data packets on the basis of the configuration rules.

Modification of packets may be performed by the inspection module 180 and probes 170. In other examples of the method 200, the modification of communication of data packets is performed at a separate logical entity from the inspection module 180 and probes 170.

In some examples, filtering rules are applied to the data packets. Filtering rules may be used to limit which data packets are used as input to model the process and identify malicious behaviour. A packet may be filtered based on the source or destination of the packet. In other cases, data packets may be filtered based on the direction or type of data packet.

The methods and systems described herein overcome disadvantages of antivirus software at network intrusion detection systems.

The methods and systems are implemented within the computing system but remain separate from the main CPU. In contrast to network-based intrusion detection methods, the inspection module has access to a large body of contextual information regarding the state of the software running on the CPU. This means the inspection module is able to more accurately analyse the CPU behaviour and correctly diagnose problems.

On the other hand, in contrast to antivirus software-based systems, which operate within the CPU, the inspection module is immune to a compromised OS on the CPU due to hardware-level separation. The inspection module can still detect threats even in the case where the OS is completely under the control of an attacker. In particular, the methods and systems can be used to detect threats such as rootkits and other kinds of sophisticated malware which remain well hidden and undetectable from the point of view of the OS. Moreover, the methods and systems described herein can take remediation action even in the case of a fully compromised CPU.

The methods and systems described herein also provide powerful new ways to control the flow of data packets between compromised components following an attack. The modification of the flow of communication data between components is also performed outside of the CPU. The methods and systems described herein therefore also provide a more flexible approach to remediation following detection of malware on a system.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

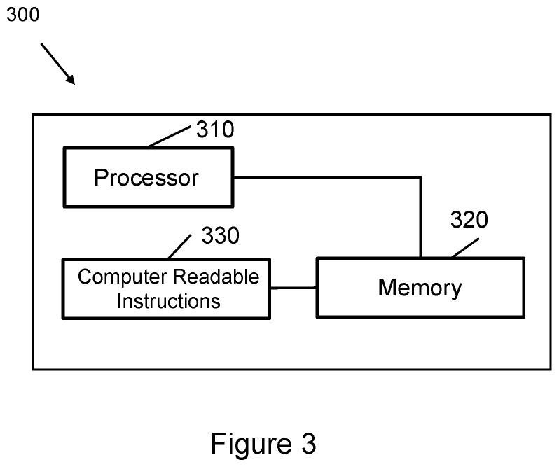

For example, the instructions may be provided on a non-transitory computer readable storage medium encoded with instructions, executable by a processor. FIG. 3 shows an example of a processor 310 associated with a memory 320. The memory 320 comprises computer readable instructions 330 which are executable by the processor 310. According to examples, a device such as a secure hardware module, that implements the inspection module, may comprise a processor and memory such as the processor 310 and memory 320.

The instructions 330 comprise instructions to: intercept data transferred between a first and second hardware component in a computing system, aggregate the data to determine a state of a process executing on the first component and apply a state model to the state to infer if the process is a malicious process.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. An apparatus for a computing system comprising a central processing unit (CPU) and at least one further hardware component, the apparatus comprising:
a probe communicatively coupled with the hardware component and the CPU, to intercept communication between the hardware component and CPU; and
an inspection module communicatively coupled to the probe, to:
access communication data intercepted at the probe relating to communication between the hardware component and CPU;
determine a state of a process executing on the CPU, on the basis of the communication data; and
apply a model to the state to infer malicious activity on the CPU.

2. The apparatus of claim 1, wherein the inspection module is arranged to apply a remediation action to the computing system on the basis of an output of the model.

3. The apparatus of claim 2, wherein the remediation action comprises an action to log the output of the model, restore the process or computing system to a previous state, reboot the computing system and/or modify the operation of the computing system, and block, modify, rewrite and/or reroute communication data between the hardware component and CPU.

4. The apparatus of claim 1, wherein the inspection module is arranged to configure the probe to forward communication data to the inspection module on the basis of a policy.

5. The apparatus of claim 4, wherein the policy comprises filtering rules that filter communication data for forwarding to the inspection module based on the source or destination, direction or type of communication data intercepted at the probe.

6. The apparatus of claim 1, wherein the model comprises state transition rules for a state machine executing the process, a probabilistic and/or heuristic state model of the computing system and/or a neural network.

7. The apparatus of claim 1, wherein the inspection module is physically separated from the CPU.

8. A method for identifying malicious activity on a computing system, the method comprising:
monitoring data packets transferred between a hardware component and central processing unit (CPU) of a computing system;
applying a model of execution of a process on the computing system on the basis of the data packets; and
determining if the process is a malicious process on the basis of the output of the model.

9. The method of claim 8, comprising applying a remediation action on the basis of the determination.

10. The method of claim 9, wherein applying a remediation action comprises:
issuing a command to the CPU; and
executing a remediation action on the basis of the command.

11. The method of claim 10, wherein the command is a command to restore the computing system to a prior state, reboot the computing system or shutdown the computing system.

12. The method of claim 9, comprising modifying the communication of data packets between the hardware component and CPU.

13. The method of claim 12, wherein modifying the communication of data packets comprises:
accessing a policy specifying configuration rules for the communication of data packets between the hardware component and CPU; and
reconfiguring communication of data packets on the basis of the configuration rules.

14. The method of claim 9, wherein monitoring data packets is performed at a probe inserted between the hardware component and central processing unit.

15. A non-transitory machine-readable storage medium encoded with instructions executable by a processor to:
intercept data transferred between a first and second hardware component in a computing system;
aggregate the data to determine a state of a process executing on the first component; and
apply a state model to the state to infer if the process is a malicious process.
